(19) United States
(12) Patent Application Publication
(10) Pub. No.: US 2026/0203200 A1
(43) Pub. Date: Jul. 16, 2026

(54) COMPILER WITH TESTING SCREEN CONTROLLER

(71) Applicant: eBay Inc., San Jose, CA (US)

(72) Inventor: Matthew Borkow, Alameda, CA (US)

(21) Appl. No.: 19/022,388

(22) Filed: Jan. 15, 2025

(51) Int. Cl. G06F 11/3668

(52) U.S. Cl. CPC G06F 11/3692; G06F 11/3688; G06F 11/3696

(57) ABSTRACT

A system for testing a graphical user interface (GUI) is provided. The system accesses, by a compiler, a page controller associated with testing operations of a GUI of an application, the page controller comprising a list of functions representing respective interactions with the GUI, and the page controller defining one or more conditions associated with executing functions in the list of functions. The system calls a subset of the list of functions of the page controller according to an order defined by a test sequence, a first function in the list of functions being dependent on a result of calling a second function in the list of functions, the compiler preventing the first function from being placed in the order defined by the test sequence before the second function. The system verifies operation of the GUI of the application in response to calling the subset of the list of functions.

### TECHNICAL FIELD

The subject matter disclosed herein generally relates to a special-purpose machine that includes a system for automated software testing and validation of graphical user interfaces (GUIs), including computerized variants of such special-purpose machines and improvements to such variants, particularly focusing on test automation frameworks that handle dynamic interface elements, cross-platform compatibility, and state management validation, and to the technologies by which such special-purpose machines become improved compared to other special-purpose machines for software quality assurance and testing purposes.

### BACKGROUND

Software testing ensures the reliability and functionality of applications, particularly those with GUIs. As applications become more complex, developers and testers need robust tools and methodologies to validate their operation. Compilers, which traditionally transform human-readable source code into machine-executable instructions, can be leveraged beyond their basic translation functions to enforce logical relationships and dependencies between different components of a program.

### SUMMARY

In some aspects, the techniques described herein relate to a system including: one or more hardware processors; and at least one machine-storage medium for storing instructions that, when executed by the one or more hardware processors, cause the one or more hardware processors to perform operations including: accessing, by a compiler, a page controller associated with testing operations of a GUI of an application, the page controller including a list of functions representing respective interactions with the GUI, and the page controller defining one or more conditions associated with executing functions in the list of functions; calling, by the compiler, a subset of the list of functions of the page controller according to an order defined by a test sequence, a first function in the list of functions being dependent on a result of calling a second function in the list of functions, the compiler preventing the first function from being placed in the order defined by the test sequence before the second function; and verifying operation of the GUI of the application in response to calling the subset of the list of functions according to the order.

In some aspects, the techniques described herein relate to a system, wherein the operations include: accessing a code segment including the page controller and the subset of the list of functions.

In some aspects, the techniques described herein relate to a system, wherein the code segment includes a single line of code that causes the page controller to be executed based on parameters including the subset of the list of functions.

In some aspects, the techniques described herein relate to a system, wherein the operations include: receiving, by the compiler, user input that defines the code segment; and processing, by the compiler, the user input as text to validate the user input based on test logic associated with the one or more conditions.

In some aspects, the techniques described herein relate to a system, wherein the operations include: determining that the user input places a third function of the list of functions in a specified position in the test sequence; determining that the third function is associated with an individual result that is excluded from outputs of prior functions in the list of functions that are placed before the third function; and generating, by the compiler, a message indicating an error in the test sequence.

In some aspects, the techniques described herein relate to a system, wherein the operations include: as characters of the text are being received, accessing a selection of functions from the list of functions that match the characters of the text; and presenting a dropdown list including the selection of functions, wherein the selection of functions is based on available results of prior functions in the code segment that have been placed in the order before the characters of the text were received.

In some aspects, the techniques described herein relate to a system, wherein the operations include: chaining the subset of the list of functions in the order defined by the test sequence.

In some aspects, the techniques described herein relate to a system, wherein the operations include: obtaining definitions of operations of each function in the list of functions from an external source, wherein one or more changes to the operations performed by an individual function in the list of functions are automatically propagated to the page controller.

In some aspects, the techniques described herein relate to a system, wherein the one or more changes include modifying an aspect of a portion of the GUI, and wherein the page controller is executed by the compiler to operate on the portion of the GUI with the modified aspect without being manually updated to reflect the one or more changes.

In some aspects, the techniques described herein relate to a system, wherein the operations include: calling the second function; determining that the second function includes a first condition; analyzing an output of the GUI in response to calling the second function to determine whether the first condition is satisfied; and waiting for the first condition to be satisfied before terminating execution of the second function.

In some aspects, the techniques described herein relate to a system, wherein the operations include: determining that the first condition has been satisfied; in response to determining that the first condition has been satisfied, returning a result associated with the second function; and calling the first function after verifying that the result associated with the second function has been returned.

In some aspects, the techniques described herein relate to a system, wherein the page controller is a first page controller, and wherein the operations include: accessing, by an individual function of the first page controller, one or more additional page controllers each having a respective set of functions.

In some aspects, the techniques described herein relate to a system, wherein the operations include: presenting a window depicting automated interaction with the GUI based on the subset of the list of functions being called.

In some aspects, the techniques described herein relate to a method including: accessing, by a compiler using one or more hardware processors, a page controller associated with testing operations of a GUI of an application, the page controller including a list of functions representing respective interactions with the GUI, the page controller defining one or more conditions associated with executing functions in the list of functions; calling, by the compiler, a subset of the list of functions of the page controller according to an order defined by a test sequence, a first function in the list of functions being dependent on a result of calling a second function in the list of functions; and verifying operation of the GUI of the application in response to calling the subset of the list of functions.

In some aspects, the techniques described herein relate to a method, further including: accessing a code segment including the page controller and the subset of the list of functions.

In some aspects, the techniques described herein relate to a method, wherein the code segment includes a single line of code that causes the page controller to be executed based on parameters including the subset of the list of functions.

In some aspects, the techniques described herein relate to a method, further including: receiving, by the compiler, user input that defines the code segment; and processing, by the compiler, the user input as text to validate the user input based on test logic associated with the one or more conditions.

In some aspects, the techniques described herein relate to a method, further including: determining that the user input places a third function of the list of functions in a specified position in the test sequence; determining that the third function is associated with an individual result that is excluded from outputs of prior functions in the list of functions that are placed before the third function; and generating, by the compiler, a message indicating an error in the test sequence.

In some aspects, the techniques described herein relate to a method, further including: as characters of the text are being received, accessing a selection of functions from the list of functions that match the characters of the text; and presenting a dropdown list including the selection of functions, wherein the selection of functions is based on available results of prior functions in the code segment that have been placed in the order before the characters of the text were received.

In some aspects, the techniques described herein relate to a machine-storage medium for storing instructions that, when executed by one or more hardware processors, cause the one or more hardware processors to perform operations including: accessing, by a compiler, a page controller associated with testing operations of a GUI of an application, the page controller including a list of functions representing respective interactions with the GUI, the page controller defining one or more conditions associated with executing functions in the list of functions; calling, by the compiler, a subset of the list of functions of the page controller according to an order defined by a test sequence, a first function in the list of functions being dependent on a result of calling a second function in the list of functions; and verifying operation of the GUI of the application in response to calling the subset of the list of functions.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some examples.

FIG. 2 illustrates a page controller, in accordance with some examples.

FIG. 3 illustrates compiler test code, in accordance with some examples.

FIG. 4 illustrates a routine for testing a GUI, in accordance with some examples.

FIG. 5 is a block diagram illustrating a representative software architecture, which may be used in conjunction with various hardware architectures herein described, in accordance with some examples.

FIG. 6 is a diagrammatic representation of a machine in the form of a computer system within which a set of instructions may be executed for causing the machine to perform any one or more of the methodologies discussed herein, in accordance with some examples.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Software testing has become increasingly complex with the widespread adoption of GUIs in modern applications. Traditional testing approaches that worked well for command-line interfaces and basic web applications have proven inadequate for handling the dynamic and stateful nature of contemporary GUI-based software. The challenges of GUI testing are compounded by the need to validate complex user interactions, handle asynchronous updates, and verify proper functionality across different browsers, devices, and operating systems.

Current GUI testing frameworks attempt to address these challenges through various automation techniques, but face some limitations. These frameworks typically rely on sequential test scripts that mirror user interactions in a linear fashion. This makes such frameworks brittle and difficult to maintain as applications evolve. The inability of compilers to enforce logical rules about application behavior and state transitions during the development phase means that many issues only surface during runtime execution, leading to unreliable test results and increased maintenance overhead.

A particular challenge in GUI testing relates to element identification and state management. As web applications become more dynamic, with elements that change position, state, and availability based on user interactions and system conditions, traditional methods of element location and state verification often fail. This can be problematic when dealing with asynchronous updates, modal dialogs, and complex state transitions that characterize modern web applications. Furthermore, environmental dependencies such as cross-browser compatibility, screen resolution variations, and device-specific rendering differences introduce additional layers of complexity to the testing process.

Existing solutions have attempted to address these challenges through various approaches, including record-and-playback tools, automated test generators, and visual regression testing. However, these solutions are unable to handle the full complexity of modern GUIs, particularly when dealing with dynamic content, complex state management, and cross-platform compatibility. Additionally, current frameworks struggle with performance issues related to UI rendering, resource utilization, and network latency, making it difficult to implement reliable and efficient testing processes at scale.

The current approach to GUI testing creates significant system inefficiencies and resource waste through multiple mechanisms. Test scripts typically maintain continuous polling loops to check for element presence and state changes, consuming excessive processor cycles and memory resources. The sequential nature of tests means that system resources remain allocated even during wait periods between test steps, leading to extended execution times and inefficient resource utilization. Furthermore, the need to maintain multiple browser instances for cross-browser testing, combined with the memory overhead of object model manipulation and event handling, creates substantial memory leaks and processing overhead. These inefficiencies are compounded by redundant element queries, unnecessary page reloads, and the continuous instantiation and destruction of test environments, all of which burden system resources without providing proportional testing value. The lack of intelligent state management also results in unnecessary test repetitions and redundant validation steps, further straining system resources and extending test execution times beyond what is technically necessary for effective validation.

The present application describes a novel system that addresses these technical challenges. Specifically, the disclosed techniques provide a page controller architecture that consolidates testing operations for GUIs by maintaining a list of functions representing interactions and defining conditions for executing those functions in the compiler. The system enables compiler-enforced test sequence ordering based on function dependencies, preventing invalid function orderings that could break test logic. By leveraging the compiler to enforce logical relationships between test functions, the system ensures that functions dependent on results from other functions cannot be executed out of order. The compiler flags and identifies such issues before the test code is ever compiled and executed. This approach reduces system inefficiencies and resource waste by eliminating redundant element queries, unnecessary page reloads, and continuous instantiation of test environments. The system also improves test maintenance by automatically propagating UI element changes through the page controller without requiring manual updates to test implementations. Additionally, the system provides method discovery capabilities that enable rapid test implementation while maintaining logical consistency through compiler-enforced test sequence validation.

As referred to herein, the term “page controller” means an object-oriented software component that encapsulates all the functionality and testing operations available for a specific page or screen of a graphical user interface. The page controller maintains a list of functions that represent the available interactions and operations that can be performed on that specific page and defines conditions associated with executing those functions, including validation that the page has been loaded successfully. The page controller works in conjunction with a page model, where the page model provides access to the UI elements (like buttons and text fields), while the controller implements the functions that use those elements and defines the expected results of those interactions. For example, on a sign-in screen, the page controller can define functions like “enter username,” “enter password,” and “tap sign in button,” along with the expected resulting page that should appear after each action. The function of the page controller is to return appropriate functions/information upon successful completion of actions, enabling the chaining of test operations while maintaining logical flow between different pages of the application.

In some examples, the disclosed techniques access, by a compiler, a page controller associated with testing operations of a GUI of an application. The page controller includes a list of functions representing respective interactions with the GUI and defines one or more conditions associated with executing functions in the list of functions. The disclosed techniques have the compiler call a subset of the list of functions of the page controller according to an order defined by a test sequence (before compiling the code and while a programmer is writing the code). A first function in the list of functions can be dependent on a result of calling a second function in the list of functions. The compiler prevents the first function from being placed in the order defined by the test sequence before the second function in the code writing stage and before compiling the code for execution. The system verifies operation of the GUI of the application in response to calling the subset of the list of functions.

As a result, one or more of the methodologies described herein facilitate solving the technical problem of testing platforms presented by conventional methods. As such, one or more of the methodologies described herein may obviate a need for certain efforts or computing resources that otherwise would be involved in generating test code using testing platforms. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

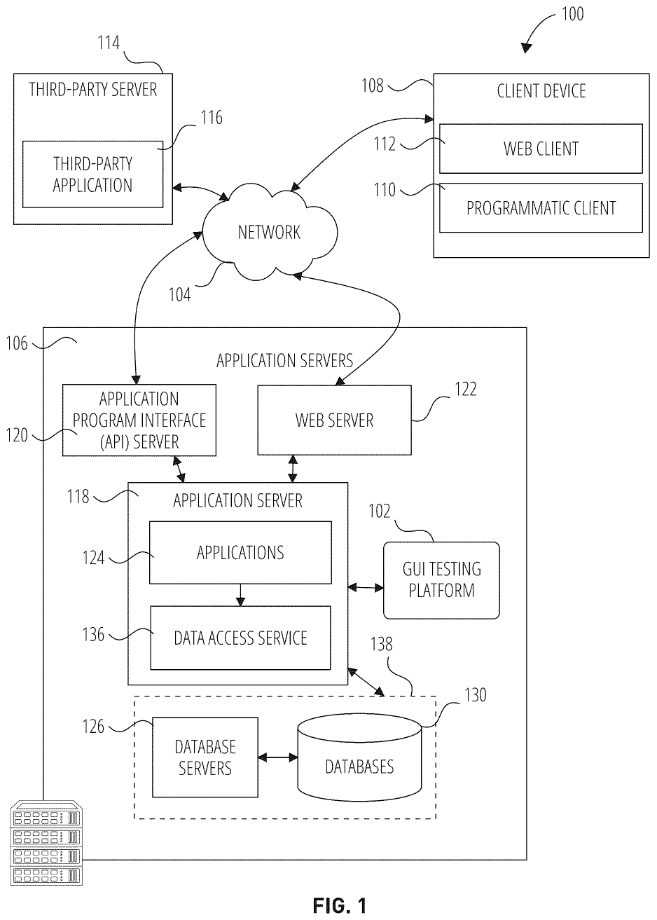

FIG. 1 is a diagrammatic representation of a network environment 100 in which some examples of the present disclosure may be implemented or deployed. One or more application servers 106 provide server-side functionality via a network 104 to a networked user device, in the form of a client device 108. A web client 112 (e.g., a browser) and a programmatic client 110 (e.g., an “app”) are hosted and execute on the web client 112.

An Application Program Interface (API) server 120 and a web server 122 provide respective programmatic and web interfaces to application servers 106. A specific application server 118 hosts an applications 124 and a data access service 136, which includes components, modules, and/or applications.

The applications 124 may provide a number of functions and services to users who access the application servers 106. For example, the applications 124 may include a publication application that enables users to publish content (e.g., product item information) on a hosted web page. While the applications 124 is shown in FIG. 1 to be part of the application servers 106, it will be appreciated that, in alternative examples, the applications 124 may be separate and distinct from the application server 118. The applications 124 can also enable buyers to purchase items from an online electronic commerce platform where users can buy and sell physical (tangible) and/or intangible items.

The data access service 136 coordinates requests from the applications 124 to access services provided by GUI testing platform 102 and to access data stored in one or more cache nodes and/or databases 130 (e.g., database servers 126) of data access layer 138. For example, the data access service 136 coordinates transaction requests from the applications 124 across distributed database servers of the GUI testing platform 102.

Further, while the network environment 100 shown in FIG. 1 employs a client-server architecture, the examples are, of course, not limited to such an architecture, and could equally well find application in a distributed, or peer-to-peer, architecture system. The applications 124 could also be implemented as a standalone software program, which do not necessarily have networking capabilities.

The web client 112 accesses the applications 124 via the web interface supported by the web server 122. Similarly, the programmatic client 110 accesses the various services, microservices, and functions provided by the applications 124 via the programmatic interface provided by the Application Program Interface (API) server 120. In one example, the programmatic client 110 may, for example, be a seller application (e.g., eBay Application developed by eBay Inc., of San Jose, California) to enable sellers to author and manage listings on the network environment 100 in an offline manner, and to perform batch-mode communications between the programmatic client 110 and the application servers 106. In one example, the programmatic client 110 may, for example, be a buyer (purchaser) application (e.g., eBay Application developed by eBay Inc., of San Jose, California) to enable buyers to search available listings for items on the network environment 100 in an online manner, to select items to purchase, and to perform batch-mode communications between the programmatic client 110 and the application servers 106.

FIG. 1 also illustrates a third-party application 116 executing on a third-party server 114 as having programmatic access to the application servers 106 via the programmatic interface provided by the Application Program Interface (API) server 120. For example, the third-party application 116 may, utilizing information retrieved from the application server 118, support one or more features or functions on a website hosted by a third party. The third-party website may, for example, provide one or more promotional, marketplace, or payment functions that are supported by the relevant applications of the application servers 106.

Any of the systems or machines (e.g., databases, devices, servers) shown in, or associated with, FIG. 1 may be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 108 may be embodied within the network environment 100. Furthermore, some components or functions of the network environment 100 may be combined or located elsewhere in the network environment 100. For example, some of the functions of the client device 108 may be embodied at the application server 118.

The GUI testing platform 102 can be used to test various operations of the network environment 100, such as any of the GUIs presented by the network environment 100. The GUI testing platform 102 can provide a comprehensive system for automated testing of GUIs through a page controller architecture. The GUI testing platform 102 operates within the network environment 100 that includes application servers 106, client devices 108, and database servers 126, enabling distributed testing across different components of the application.

In some examples, the GUI testing platform 102 implements a page controller that consolidates both the state and functionality of GUI screens being tested. The GUI testing platform 102 accesses page controllers associated with testing operations, where each page controller maintains a list of functions representing possible interactions with the GUI and defines conditions for executing those functions. This architecture allows the platform to manage test sequences while enforcing logical dependencies between different testing operations during code writing and prior to compiling any code.

The GUI testing platform 102 leverages the compiler to enforce test sequence ordering based on function dependencies. For example, when testing a sign-in workflow, the GUI testing platform 102 can prevent functions that depend on successful authentication from being executed (or written without being flagged as improper or error prone) before the sign-in function completes or is written in the test sequence. This compiler-based validation ensures that test sequences maintain logical consistency and prevents invalid operation ordering that could lead to test failures.

The GUI testing platform 102 also implements automatic propagation of UI element changes through the page controller architecture. When aspects of the GUI are modified, such as changing element identifiers or updating workflow paths, these changes are automatically reflected in the page controller without requiring manual updates to test implementations. This can reduce maintenance overhead and ensure test reliability even as the application evolves.

Additionally, the GUI testing platform 102 can provide method or function discovery capabilities that enable rapid test implementation while maintaining logical consistency. As developers write test sequences, the GUI testing platform 102 can suggest available functions based on the current state and previous operations or functions that are written, as defined by the page controller. This ensures that only valid operations are included in the test sequence. This combination of compiler enforcement and intelligent function suggestion helps prevent common testing errors and improves overall test reliability.

Specifically, the GUI testing platform 102 can perform several operations in executing automated testing. Initially, the compiler of the GUI testing platform 102 accesses a page controller associated with GUI testing operations, which maintains a list of functions representing possible interactions and defines conditions for their execution. The compiler then calls specific functions from this list according to a defined test sequence, ensuring proper ordering by preventing functions that depend on results from other functions from executing prematurely.

In some implementations, the GUI testing platform 102 accesses code segments that include both the page controller and selected functions. These segments can be as concise as a single line of code that triggers page controller execution based on specified function parameters. The GUI testing platform 102 processes user input through its compiler, which validates the input text against test logic associated with defined conditions. During validation, the compiler analyzes function placement within test sequences, identifying cases where functions are positioned incorrectly relative to their dependencies. For example, if a function requires results not available from previously executed functions, the compiler generates appropriate error messages.

To assist with test development, the GUI testing platform 102 implements real-time function suggestion capabilities. As users enter text, the GUI testing platform 102 presents dropdown lists of matching functions, filtered based on available results from previously placed functions in the code segment. The GUI testing platform 102 also supports function chaining according to the defined test sequence order.

The GUI testing platform 102 can maintain flexibility through external operation definitions. When changes occur to individual function operations, these modifications automatically propagate through the page controller without requiring manual updates. This includes changes to GUI elements, allowing the page controller to adapt to modified interfaces automatically.

In some examples, during execution, the GUI testing platform 102 implements condition checking. When calling functions, the GUI testing platform 102 can analyze GUI outputs to verify condition satisfaction before proceeding. Functions return results only after their conditions are met. This ensures proper sequencing of dependent operations. The GUI testing platform 102 can support hierarchical testing structures through nested page controllers. Individual functions can access additional page controllers, each with their own function sets. Throughout the testing process, the GUI testing platform 102 can display windows showing automated GUI interactions based on the executed functions. These operations can be implemented across different system configurations, including methods executed by hardware processors and instructions stored on machine-storage media. The GUI testing platform 102 can maintain consistent functionality across these implementations while enforcing proper function ordering and dependency management through compiler-based validation.

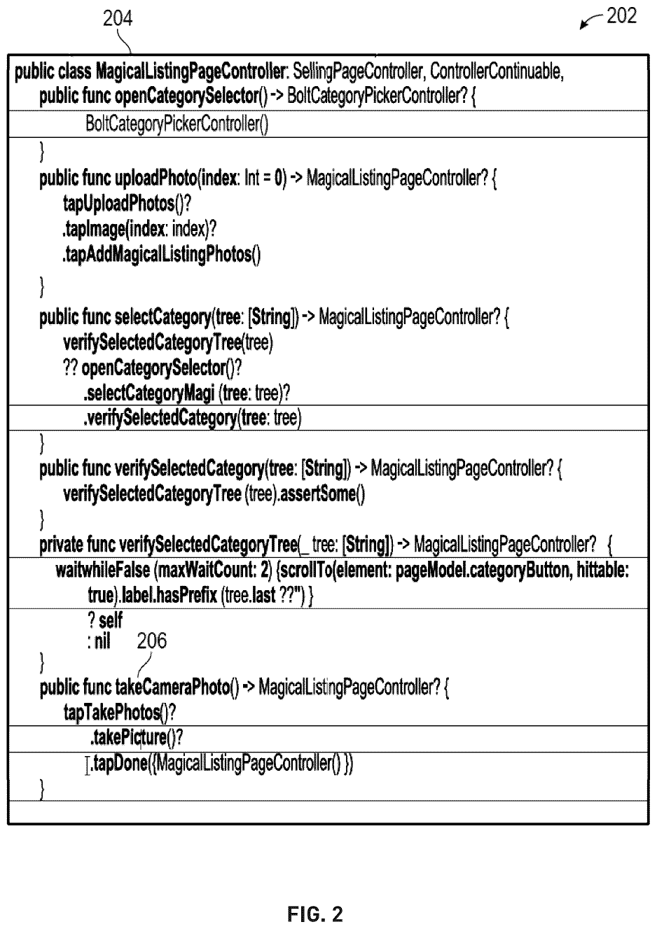

FIG. 2 illustrates a page controller, in accordance with some examples. Specifically, FIG. 2 shows a certain page controller 202, referred to as a MagicalListingPageController represented by the page controller identifier 204. The page controller 202 can inherit properties and functions from various page models and/or other page controllers, such as the SellingPageController, and/or the ControllerContinuable interface.

In some examples, the page controller 202 includes functions that represent possible interactions with the GUI or page model, including an openCategorySelector function, uploadPhoto function, selectCategory function, verifySelectedCategory function, and/or takeCameraPhoto (e.g., page controller function 206). Each of these functions can be designed to return either the same controller or a new controller based on the operation's result. In some cases, the result of one function in the page controller 202 can depend on the output of another function in the same page controller 202 or a different page controller.

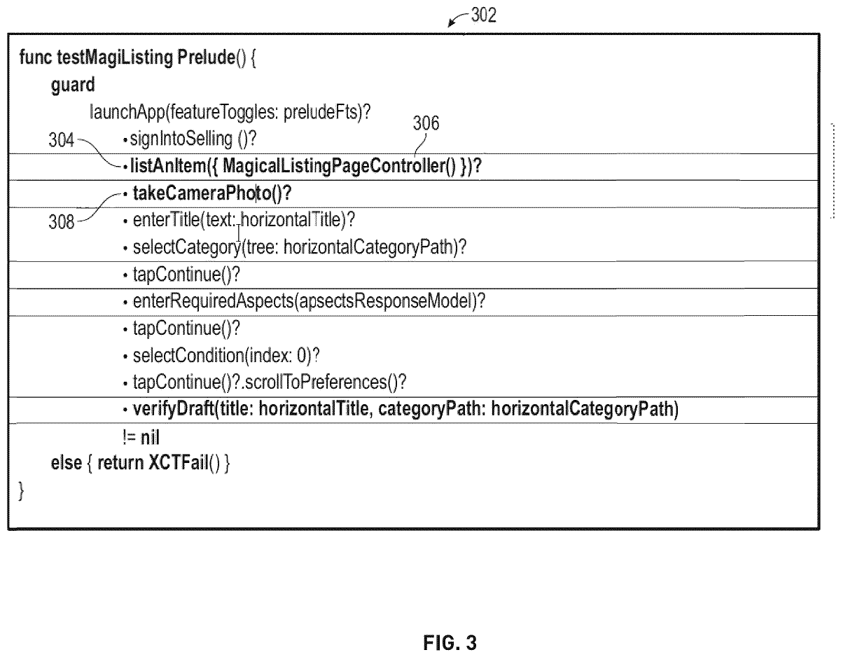

The GUI testing platform 102 uses this page controller 202 to enforce function dependencies through compiler validation. This is particularly evident in the relationship between the listAnItem function and the takeCameraPhoto function shown in the compiler test code 302 written in FIG. 3. Specifically, the takeCameraPhoto function (e.g., second test function 308), defined within the MagicalListingPageController (e.g., page controller identifier 306) of page controller 202, represents a sequence of operations: tapping the take photos button, taking a picture, and tapping the done button. This second test function 308 can only be accessed through an instance of the MagicalListingPageController.

In FIG. 3, an example test sequence demonstrates this dependency enforcement. The sequence begins with the launchApp function and signIntoSelling operations, followed by the listAnItem function, such as first test function 304, which returns a MagicalListingPageController. The takeCameraPhoto function (e.g., the second test function 308) can be called only after the listAnItem function (e.g., first test function 304) successfully executes. The compiler enforces this dependency by preventing the takeCameraPhoto function from being placed or written in the test sequence before the listAnItem function. This is because the takeCameraPhoto is a method of the MagicalListingPageController, which is only available after the listAnItem function executes and returns an instance of that controller, such as page controller 202.

If a developer attempts to write code in which the takeCameraPhoto function is placed in the sequence before the listAnItem function, the compiler can generate an error. This is because no instance of MagicalListingPageController exists yet. In such cases, the compiler can visually distinguish, such as by greying out, the takeCameraPhoto function and/or can present a message indicating the error to the developer. In some cases, the compiler can inform the developer what other function needs to be called before the takeCameraPhoto function in order to resolve this dependency error.

As another example, the enterRequiredAspects function is related in dependency on the tapContinue function in the test sequence of the compiler test code 302. Namely, the enterRequiredAspects function can only be called after tapContinue has been executed on the category selection page, as it requires the aspects page controller to be active. In FIG. 3, this dependency is shown as enforced where enterRequiredAspects cannot be placed before the tapContinue function that follows category selection.

This is because enterRequiredAspects is a method available only on the aspects page controller, which is returned by the tapContinue function called from the selectCategory function or page. The compiler enforces this dependency by preventing enterRequiredAspects from being called before the proper page controller is instantiated through tapContinue. If a developer attempts to call enterRequiredAspects directly after selectCategory without the intervening tapContinue, the compiler can generate an error since no aspects page controller exists yet.

Similarly, the selectCondition function demonstrates another dependency relationship. The selectCondition function can only be called after tapContinue has been executed on the aspects page, as it requires the condition page controller. The platform ensures that the proper sequence is maintained: enterRequiredAspects->tapContinue->selectCondition. This dependency chain continues throughout the test sequence.

The GUI testing platform 102 enforces these dependencies through compiler validation of the controller types and their availability at each point in the test sequence. Each function must be called on a valid controller instance that exists as a result of previous operations in the sequence. This enforcement ensures that test sequences maintain logical consistency and follow the application's actual workflow. Functions cannot be called out of order or without their required prerequisites being satisfied, preventing invalid test scenarios and improving overall test reliability.

This compiler-based validation ensures logical consistency in the test sequence. The page controller 202 structure enables method chaining, where each function returns either the same controller instance or a new controller instance. For example, the takeCameraPhoto function can return the MagicalListingPageController, allowing subsequent operations to be chained.

The GUI testing platform 102 leverages this architecture to maintain test sequence integrity. When processing the compiler test code 302 shown in FIG. 3, the GUI testing platform 102 ensures that operations are executed in a logically valid order. The GUI testing platform 102 validates that the MagicalListingPageController is properly instantiated through the listAnItem function before allowing any of its methods, including takeCameraPhoto, to be called. This validation can occur during both development and execution.

During development, the compiler of the GUI testing platform 102 prevents invalid function ordering through type checking and dependency validation. During execution, the GUI testing platform 102 ensures that each controller operation completes successfully before proceeding. The page controller 202 can implement a verifySelectedCategory function that demonstrates how validation works within the controller. This function returns the controller instance only after successfully verifying the selected category, ensuring proper state management.

Similar validation occurs throughout the test sequence. Each function in the chain must complete successfully and return the appropriate controller before subsequent functions can execute. The GUI testing platform 102 compiler enforces these dependencies by analyzing the return types of functions and their placement in the test sequence. The GUI testing platform 102 ensures that functions are only called on valid controller instances that exist at that point in the sequence.

In the case of takeCameraPhoto, the compiler verifies that the second test function 308 is being called on a valid instance of MagicalListingPageController. This instance may need to be obtained through proper initialization via the listAnItem function (first test function 304).

In some cases, the page controller 202 architecture also supports nested operations. For example, the takeCameraPhoto function internally chains multiple operations (tap photos, take picture, tap done) while maintaining the overall controller context. This nested operation support enables complex test sequences while maintaining logical consistency. Each operation within takeCameraPhoto may need to complete successfully before the function returns the controller instance.

Through this comprehensive dependency management, the GUI testing platform 102 ensures that test sequences remain logically valid and maintainable. The GUI testing platform 102 enforcement of these dependencies prevents common testing errors and improves overall test reliability. The page controller 202 design also facilitates test maintenance. When changes occur in the GUI, the relevant controller functions may be updated, while existing test sequences remain valid as long as they follow the proper function ordering.

In some examples, the GUI testing platform 102 implements self-validation through page controller constructors. This can provide automated verification of page states and elements. For example, when a page controller 202 is instantiated, the page controller 202 validates that the required elements exist before allowing any operations to proceed. Namely, when the MagicalListingPageController is instantiated through the listAnItem function in FIG. 3, its constructor automatically verifies that certain page elements are present and properly loaded. This validation occurs in response to calling the controller in the compiler, and if validation fails, the test fails immediately rather than proceeding with an invalid state.

The GUI testing platform 102 can consolidate all validation logic within the controller constructor. This eliminates redundant validation code that would otherwise be scattered across multiple test implementations. This centralized approach means that all tests using a particular controller automatically inherit the same validation checks, ensuring consistent verification across the test suite. For example, rather than having dozens of tests each verifying that a sign-in page's username field, password field, and sign-in button exist, these checks are performed once in the constructor of the page controller 202.

The constructor-based validation of the GUI testing platform 102 also supports complex state management. When a controller is instantiated, it can verify not just the presence of elements but also their state and relationships. For instance, the MagicalListingPageController's constructor might verify that certain buttons are enabled, specific text fields are empty, or particular elements are visible before allowing test execution to proceed. This validation architecture ensures that tests can only proceed when pages are in their expected states, preventing test failures that might occur due to timing issues or unexpected page conditions. The platform 102 enforces these validations consistently across all tests that use the controller, improving overall test reliability while reducing the amount of validation code that needs to be maintained.

The GUI testing platform 102 can implement polymorphism, as demonstrated by the tap continue functionality across different page controllers. In this way, this polymorphism enables each controller to have its own implementation of tapContinue that returns different controller types based on the specific workflow context. For example, when executing the test sequence shown in FIG. 3, the tapContinue function demonstrates different behaviors depending on which controller calls it. After category selection, tapContinue returns an aspects page controller, while calling tapContinue on the aspects page returns a condition page controller.

Each implementation, though sharing the same function name, is specific to its controller and produces different results. The GUI testing platform 102 leverages this polymorphic behavior to enforce workflow dependencies. When tapContinue (or other suitable UI element) is called on the MagicalListingPageController after selecting a category, it specifically returns the aspects page controller needed for the next step in the workflow. The compiler validates that subsequent operations are only called on the appropriate returned controller, ensuring logical consistency in the test sequence.

This polymorphic architecture enables the GUI testing platform 102 to maintain clear separation between different pages while enforcing proper workflow transitions. For instance, after entering required aspects and calling tapContinue, the platform returns a condition page controller, allowing only condition-related operations to be performed next. The compiler enforces these transitions by ensuring functions are only called on valid controller instances that exist at that point in the sequence. The implementation of polymorphism through tapContinue also facilitates test maintenance and reusability.

When workflow changes occur, only the specific tapContinue implementation in the affected controller needs to be updated, while the overall test sequence structure remains intact. This encapsulation of page-specific logic within each implementation of the controller helps maintain test reliability while supporting evolving application workflows. Through this polymorphic approach, the GUI testing platform 102 ensures that test sequences follow valid application workflows while preventing invalid operation ordering. The compiler enforces these workflow transitions by validating that operations are only called on the appropriate controller instances returned by previous tapContinue calls. TapContinue is shown for illustrative purposes, and similar functionality applies to other types of operations/functions, such as tapConfirm or tapSelect (indicating selection of a particular UI element).

In some examples, the GUI testing platform 102 implements method discovery capabilities during test development to assist developers in writing valid test sequences. As developers write test code, the GUI testing platform 102 provides intelligent function suggestions based on the current controller context and available operations. When writing test sequences like those shown in FIG. 3, the platform presents developers with dropdown lists of available functions that match their input text. These suggestions are dynamically filtered based on the available results from previously placed functions in the code segment, ensuring that only valid operations are presented.

For example, after the listAnItem function returns a MagicalListingPageController, the method discovery presents only the functions available on that controller, such as takeCameraPhoto, enterTitle, and selectCategory. This discovery mechanism helps developers understand what operations are valid at each point in the test sequence while preventing invalid function selections.

The method discovery capabilities extend to parameter suggestions as well. When functions require specific parameters, the platform can present valid options based on the current context and available data. This helps ensure that developers not only select valid functions but also provide appropriate parameters for those functions. If developers attempt to use functions that are not available in the current context, the GUI testing platform 102 provides clear feedback about why those functions cannot be used and what prerequisites need to be satisfied.

For instance, if a developer tries to use takeCameraPhoto before listAnItem, the GUI testing platform 102 indicates that the function requires a MagicalListingPageController instance. The method discovery system also provides a clear implementation strategy when needed functionality does not exist. If developers cannot find a required function in the suggestions, they know they need to implement that function in the appropriate controller. This helps maintain the logical structure of the test framework while enabling extension of testing capabilities.

Through these discovery capabilities, the GUI testing platform 102 improves the test development process by guiding developers toward valid function selections while maintaining logical consistency in test sequences. The combination of intelligent suggestions and clear feedback helps prevent common testing errors while reducing the time required to implement new test cases.

In some examples, the GUI testing platform 102 implements a visual testing interface that displays automated interactions with the GUI alongside the compiler code. The GUI testing platform 102 presents a window depicting the automated interactions as they occur based on the subset of functions being called in the test sequence. During test execution, developers can observe the actual GUI interactions corresponding to each function call in the test sequence. For example, when the takeCameraPhoto function executes in FIG. 3, the GUI testing platform 102 displays a window showing the automated interaction with the camera GUI, including tapping the take photos button, capturing the image, and tapping the done button.

The GUI testing platform 102 enables step-by-step progression through the test sequence, allowing developers to observe each interaction as it occurs. As the compiler executes each function in the sequence shown in FIG. 3, such as listAnItem followed by takeCameraPhoto, the corresponding GUI interactions are displayed in real-time in the presentation window. This visual representation helps developers verify that automated interactions match expected behavior. When functions like enterRequiredAspects or selectCategory are called, developers can observe the actual GUI elements being manipulated and validate that proper workflows are being followed.

In some examples, the GUI testing platform 102 implements an implementation strategy when developers need new testing functionality. When writing test sequences, if developers discover they need a function that does not exist in the current controller, the GUI testing platform 102 can provide a path for implementation. For example, when developing test sequences like those shown in FIG. 3, developers may identify the need for additional functionality on a particular page controller.

The method discovery capabilities make it apparent which functions are available, and by extension, which functions need to be implemented. If a developer needs to verify an aspect on the item specifics page that is not currently supported, the implementation strategy is clear the developer can create that verification method within the item specifics page controller. Once implemented in the controller, the new function becomes available to all tests using that controller, promoting code reuse and maintaining logical consistency.

This guidance ensures that new functionality is implemented in the appropriate location while maintaining the architectural structure of the testing framework. This implementation strategy helps maintain the separation between page models and controllers. While the page model provides access to UI elements, new testing functionality is implemented in the controller, preserving the clean separation of concerns. For instance, if a new verification is needed for a particular UI element, the element location remains in the page model while the verification logic is implemented in the controller. Once a new function is implemented in a controller, it becomes part of the method discovery system and can be suggested to developers when writing test sequences.

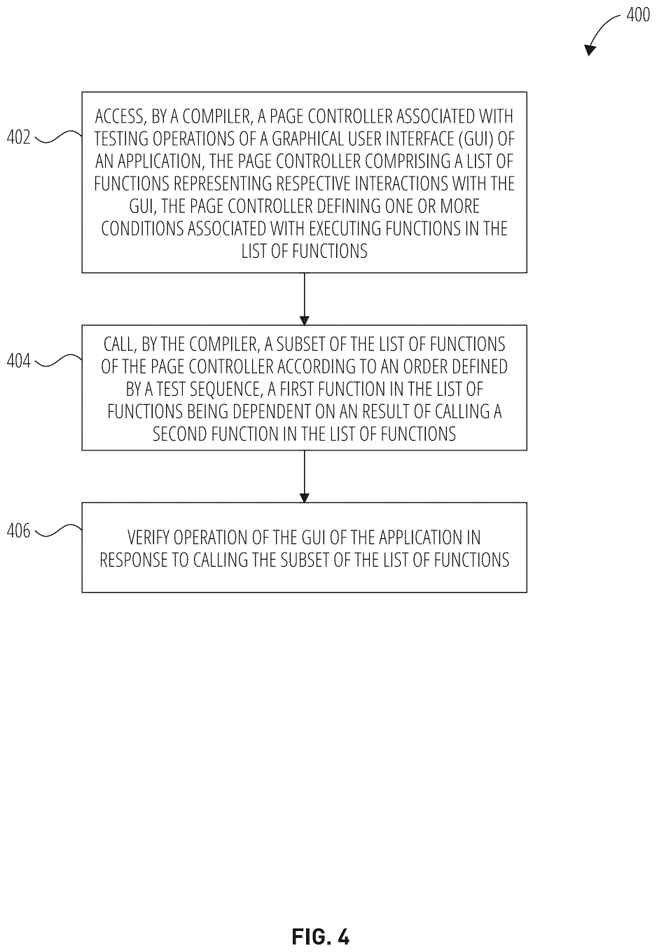

FIG. 4 illustrates a routine 400 (e.g., method or process) in accordance with some examples. The operations discussed in connection with FIG. 4 can be performed sequentially, in parallel, and in any suitable order. The operations discussed in FIG. 4 can be performed by the GUI testing platform 102.

In operation 402, the GUI testing platform 102 accesses, by a compiler, a page controller associated with testing operations of a GUI of an application. The page controller includes a list of functions representing respective interactions with the GUI and the page controller defines one or more conditions associated with executing functions in the list of functions, as discussed above.

In operation 404, the GUI testing platform 102 calls, by the compiler, a subset of the list of functions of the page controller according to an order defined by a test sequence. A first function in the list of functions can be dependent on a result of calling a second function in the list of functions. The compiler can prevent the first function from being placed in the order defined by the test sequence before the second function, as discussed above.

In operation 406, the GUI testing platform 102 verifies operation of the GUI of the application in response to calling the subset of the list of functions according to the order, as discussed above.

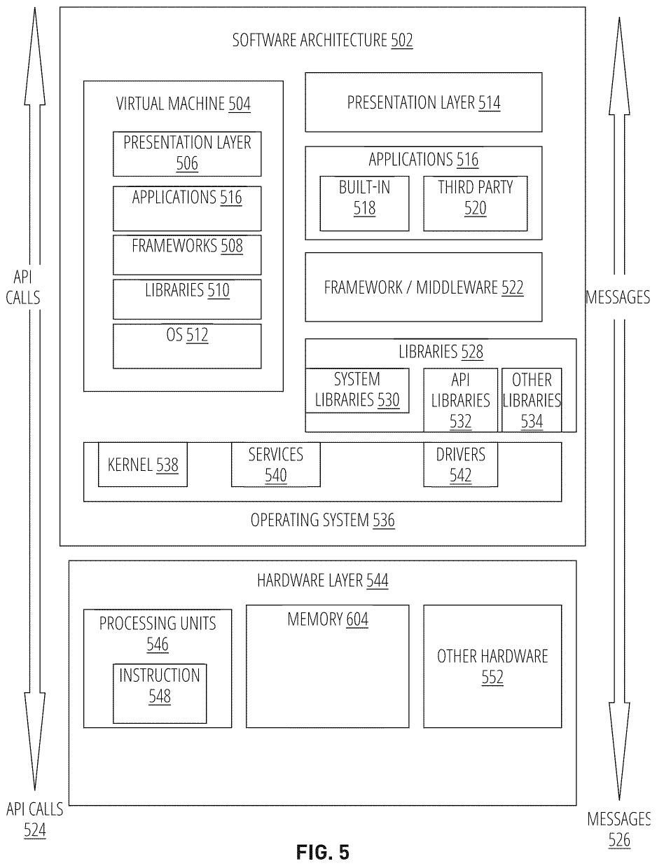

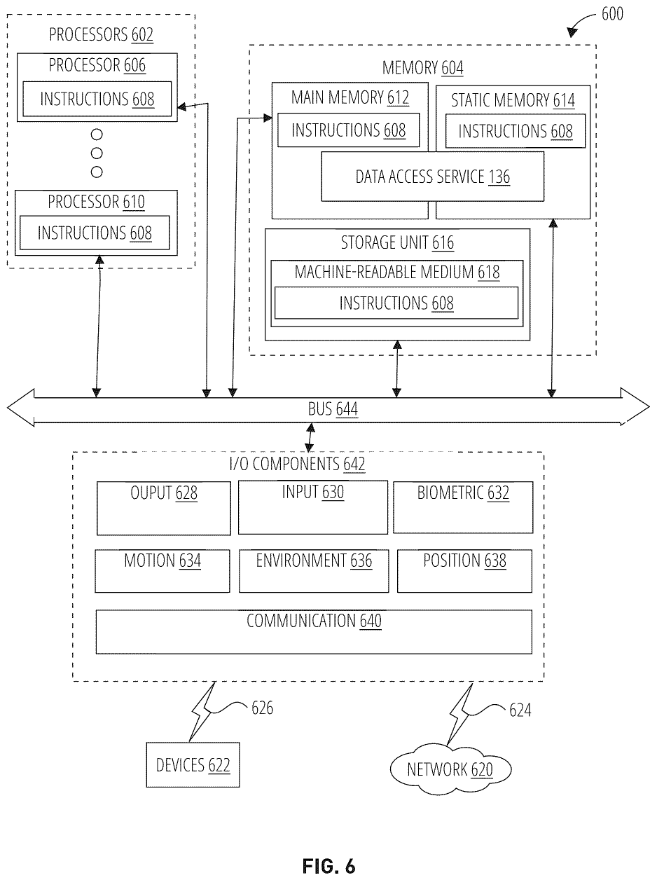

FIG. 5 is a block diagram illustrating an example of a software architecture 502 that may be installed on a machine, according to some examples. FIG. 5 is merely a non-limiting example of a software architecture, and it will be appreciated that many other architectures may be implemented to facilitate the functionality described herein. The software architecture 502 may be executing on hardware such as a machine 600 of FIG. 6 that includes, among other things, processors 610, memory 604, and I/O components 642. A representative hardware layer 544 is illustrated and can represent, for example, the machine 600 of FIG. 6. The representative hardware layer 544 comprises one or more processing units 546 having associated executable instructions 548. The executable instructions 548 represent the executable instructions of the software architecture 502. The hardware layer 544 also includes memory 604, which also have the executable instructions 548. The hardware layer 544 may also comprise other hardware 552, which represents any other hardware of the hardware layer 544, such as the other hardware illustrated as part of the machine 600.

The instructions 548 may be transmitted or received over the network using a transmission medium via a network interface device (e.g., a network interface component included in the communication components 640) and utilizing any one of a number of well-known transfer protocols (e.g., hypertext transfer protocol (HTTP)). Similarly, the instructions 548 may be transmitted or received using a transmission medium via the coupling (e.g., a peer-to-peer coupling) to the devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 548 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” are non-transitory computer-readable media and specifically exclude carrier waves, modulated data signals, and other such media, at least some of which are covered under the term “signal medium.”

In the example architecture of FIG. 5, the software architecture 502 may be conceptualized as a stack of layers, where each layer provides particular functionality. For example, the software architecture 502 may include layers such as an operating system 536, libraries 528, framework/middleware 522, applications 516, and a presentation layer 514. Operationally, the applications 516 or other components within the layers may invoke API calls API calls 524 through the software stack and receive a response, returned values, and so forth (illustrated as messages 526) in response to the API calls 524. The layers illustrated are representative in nature, and not all software architectures have all layers. For example, some mobile or special-purpose operating systems may not provide a framework/middleware 522 layer, while others may provide such a layer. Other software architectures may include additional or different layers.

The operating system 536 may manage hardware resources and provide common services. The operating system 536 may include, for example, a kernel 538, services 540, and drivers 542. The kernel 538 may act as an abstraction layer between the hardware and the other software layers. For example, the kernel 538 may be responsible for memory management, processor management (e.g., scheduling), component management, networking, security settings, and so on. The services 540 may provide other common services for the other software layers. The drivers 542 may be responsible for controlling or interfacing with the underlying hardware. For instance, the drivers 542 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 528 may provide a common infrastructure that may be utilized by the applications 516 and/or other components and/or layers. The libraries 528 typically provide functionality that allows other software modules to perform tasks in an easier fashion than by interfacing directly with the underlying operating system 536 functionality (e.g., kernel 538, services 540, or drivers 542). The libraries 528 may include system libraries 530 (e.g., C standard library) that may provide functions such as memory allocation functions, string manipulation functions, mathematic functions, and the like. In addition, the libraries 528 may include API libraries 532 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 528 may also include a wide variety of other libraries 534 to provide many other APIs to the applications 516 and other software components/modules.

The frameworks/middleware 522 (also sometimes referred to as middleware) may provide a higher-level common infrastructure that may be utilized by the applications 516 or other software components/modules. For example, the frameworks/middleware 522 may provide various graphical user interface functions, high-level resource management, high-level location services, and so forth. The frameworks/middleware 522 may provide a broad spectrum of other APIs that may be utilized by the applications 516 and/or other software components/modules, some of which may be specific to a particular operating system or platform.

The applications 516 include built-in applications 518 and/or third-party applications 520. Examples of representative built-in applications 518 may include, but are not limited to, a home application, a contacts application, a browser application, a book reader application, a location application, a media application, a messaging application, or a game application.

The third-party applications 520 may include any of the built-in applications 518, as well as a broad assortment of other applications. In a specific example, the third-party applications 520 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 520 may invoke the API calls 524 provided by the mobile operating system such as the operating system 536 to facilitate functionality described herein.

The applications 516 may utilize built-in operating system functions (e.g., kernel 538, services 540, or drivers 542), libraries (e.g., system libraries 530, API libraries 532, and other libraries 534), or framework/middleware 522 to create user interfaces to interact with users of the system. Alternatively, or additionally, in some systems, interactions with a user may occur through a presentation layer, such as the presentation layer 514. In these systems, the application/module “logic” can be separated from the aspects of the application/module that interact with the user.

Some software architectures utilize virtual machines. In the example of FIG. 5, this is illustrated by a virtual machine 504. The virtual machine 504 creates a software environment where applications/modules can execute as if they were executing on a hardware machine (e.g., the machine 600 of FIG. 6). The virtual machine 504 is hosted by a host operating system (e.g., the operating system 536) and typically, although not always, has a virtual machine monitor, which manages the operation of the virtual machine 504 as well as the interface with the host operating system (e.g., the operating system 536). A software architecture executes within the virtual machine 504, such as an operating system 512, libraries 510, frameworks 508, applications 516, or a presentation layer 506. These layers of software architecture executing within the virtual machine 504 can be the same as corresponding layers previously described or may be different.

FIG. 6 is a diagrammatic representation of the machine 600 within which instructions 608 (e.g., software, a program, an application, an applet, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include processors 602, memory 604, and I/O components 642, which may be configured to communicate with each other via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the processors 602 via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the processors 602 (e.g., within the processor's cache memory), or any suitable combination thereof, during execution thereof by the machine 600.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones may include a touch input device or other such input mechanisms, while a headless server machine will likely not include such a touch input device. It will be appreciated that the I/O components 642 may include many other components that are not shown in FIG. 6. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 642 may include biometric components 632, motion components 634, environmental components 636, or position components 638, among a wide array of other components. For example, the biometric components 632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 include acceleration sensor components (e.g., accelerometer), gravitation sensor components, rotation sensor components (e.g., gyroscope), and so forth. The environmental components 636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 further include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614, and/or memory of the processors 602) and/or storage unit 616 may store one or more sets of instructions and data structures (e.g., software) embodying or used by any one or more of the methodologies or functions described herein. These instructions (e.g., the instructions 608), when executed by processors 602, cause various operations to implement the disclosed examples.

The instructions 608 may be transmitted or received over the network 620, using a transmission medium, via a network interface device (e.g., a network interface component included in the communication components 640) and using any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622.

Although examples have been described, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

In view of the disclosure above, various examples are set forth below. It should be noted that one or more features of an example, taken in isolation or combination, should be considered within the disclosure of this application.

### EXAMPLE 1

A system comprising: one or more hardware processors; and at least one machine-storage medium for storing instructions that, when executed by the one or more hardware processors, cause the one or more hardware processors to perform operations comprising: accessing, by a compiler, a page controller associated with testing operations of a graphical user interface (GUI) of an application, the page controller comprising a list of functions representing respective interactions with the GUI, and the page controller defining one or more conditions associated with executing functions in the list of functions; calling, by the compiler, a subset of the list of functions of the page controller according to an order defined by a test sequence, a first function in the list of functions being dependent on a result of calling a second function in the list of functions, the compiler preventing the first function from being placed in the order defined by the test sequence before the second function; and verifying operation of the GUI of the application in response to calling the subset of the list of functions according to the order.

### EXAMPLE 2

The system of Example 1, wherein the operations comprise: accessing a code segment comprising the page controller and the subset of the list of functions.

### EXAMPLE 3

The system of Example 2, wherein the code segment comprises a single line of code that causes the page controller to be executed based on parameters comprising the subset of the list of functions.

### EXAMPLE 4

The system of any one of Examples 2-3, wherein the operations comprise: receiving, by the compiler, user input that defines the code segment; and processing, by the compiler, the user input as text to validate the user input based on test logic associated with the one or more conditions.

### EXAMPLE 5

The system of Example 4, wherein the operations comprise: determining that the user input places a third function of the list of functions in a specified position in the test sequence; determining that the third function is associated with an individual result that is excluded from outputs of prior functions in the list of functions that are placed before the third function; and generating, by the compiler, a message indicating an error in the test sequence.

### EXAMPLE 6

The system of any one of Examples 4-5, wherein the operations comprise: as characters of the text are being received, accessing a selection of functions from the list of functions that match the characters of the text; and presenting a dropdown list comprising the selection of functions, wherein the selection of functions is based on available results of prior functions in the code segment that have been placed in the order before the characters of the text were received.

### EXAMPLE 7

The system of any one of Examples 1-6, wherein the operations comprise: chaining the subset of the list of functions in the order defined by the test sequence.

### EXAMPLE 8

The system of any one of Examples 1-7, wherein the operations comprise: obtaining definitions of operations of each function in the list of functions from an external source, wherein one or more changes to the operations performed by an individual function in the list of functions are automatically propagated to the page controller.

### EXAMPLE 9

The system of Example 8, wherein the one or more changes comprise modifying an aspect of a portion of the GUI, and wherein the page controller is executed by the compiler to operate on the portion of the GUI with the modified aspect without being manually updated to reflect the one or more changes.

### EXAMPLE 10

The system of any one of Examples 1-9, wherein the operations comprise: calling the second function; determining that the second function comprises a first condition; analyzing an output of the GUI in response to calling the second function to determine whether the first condition is satisfied; and waiting for the first condition to be satisfied before terminating execution of the second function.

### EXAMPLE 11

The system of Example 10, wherein the operations comprise: determining that the first condition has been satisfied; in response to determining that the first condition has been satisfied, returning a result associated with the second function; and calling the first function after verifying that the result associated with the second function has been returned.

### EXAMPLE 12

The system of any one of Examples 1-11, wherein the page controller is a first page controller, and wherein the operations comprise: accessing, by an individual function of the first page controller, one or more additional page controllers each having a respective set of functions.

### EXAMPLE 13

The system of any one of Examples 1-12, wherein the operations comprise: presenting a window depicting automated interaction with the GUI based on the subset of the list of functions being called.

### EXAMPLE 14

A method comprising: accessing, by a compiler using one or more hardware processors, a page controller associated with testing operations of a graphical user interface (GUI) of an application, the page controller comprising a list of functions representing respective interactions with the GUI, the page controller defining one or more conditions associated with executing functions in the list of functions; calling, by the compiler, a subset of the list of functions of the page controller according to an order defined by a test sequence, a first function in the list of functions being dependent on a result of calling a second function in the list of functions; and verifying operation of the GUI of the application in response to calling the subset of the list of functions.

### EXAMPLE 15

The method of Example 14, further comprising: accessing a code segment comprising the page controller and the subset of the list of functions.

### EXAMPLE 16

The method of Example 15, wherein the code segment comprises a single line of code that causes the page controller to be executed based on parameters comprising the subset of the list of functions.

### EXAMPLE 17

The method of any one of Examples 15-16, further comprising: receiving, by the compiler, user input that defines the code segment; and processing, by the compiler, the user input as text to validate the user input based on test logic associated with the one or more conditions.

### EXAMPLE 18

The method of Example 17, further comprising: determining that the user input places a third function of the list of functions in a specified position in the test sequence; determining that the third function is associated with an individual result that is excluded from outputs of prior functions in the list of functions that are placed before the third function; and generating, by the compiler, a message indicating an error in the test sequence.

### EXAMPLE 19

The method of any one of Examples 17-18, further comprising: as characters of the text are being received, accessing a selection of functions from the list of functions that match the characters of the text; and presenting a dropdown list comprising the selection of functions, wherein the selection of functions is based on available results of prior functions in the code segment that have been placed in the order before the characters of the text were received.

### EXAMPLE 20

A machine-storage medium for storing instructions that, when executed by one or more hardware processors, cause the one or more hardware processors to perform operations comprising: accessing, by a compiler, a page controller associated with testing operations of a graphical user interface (GUI) of an application, the page controller comprising a list of functions representing respective interactions with the GUI, the page controller defining one or more conditions associated with executing functions in the list of functions; calling, by the compiler, a subset of the list of functions of the page controller according to an order defined by a test sequence, a first function in the list of functions being dependent on a result of calling a second function in the list of functions; and verifying operation of the GUI of the application in response to calling the subset of the list of functions.

What is claimed is:

1. A system comprising:
one or more hardware processors; and
at least one machine-storage medium for storing instructions that, when executed by the one or more hardware processors, cause the one or more hardware processors to perform operations comprising:
accessing, by a compiler, a page controller associated with testing operations of a graphical user interface (GUI) of an application, the page controller comprising a list of functions representing respective interactions with the GUI, and the page controller defining one or more conditions associated with executing functions in the list of functions;
calling, by the compiler, a subset of the list of functions of the page controller according to an order defined by a test sequence, a first function in the list of functions being dependent on a result of calling a second function in the list of functions, the compiler preventing the first function from being placed in the order defined by the test sequence before the second function; and
verifying operation of the GUI of the application in response to calling the subset of the list of functions according to the order.

2. The system of claim 1, wherein the operations comprise:
accessing a code segment comprising the page controller and the subset of the list of functions.

3. The system of claim 2, wherein the code segment comprises a single line of code that causes the page controller to be executed based on parameters comprising the subset of the list of functions.

4. The system of claim 2, wherein the operations comprise:
receiving, by the compiler, user input that defines the code segment; and
processing, by the compiler, the user input as text to validate the user input based on test logic associated with the one or more conditions.

5. The system of claim 4, wherein the operations comprise:
determining that the user input places a third function of the list of functions in a specified position in the test sequence;
determining that the third function is associated with an individual result that is excluded from outputs of prior functions in the list of functions that are placed before the third function; and
generating, by the compiler, a message indicating an error in the test sequence.

6. The system of claim 4, wherein the operations comprise:
as characters of the text are being received, accessing a selection of functions from the list of functions that match the characters of the text; and
presenting a dropdown list comprising the selection of functions, wherein the selection of functions is based on available results of prior functions in the code segment that have been placed in the order before the characters of the text were received.

7. The system of claim 1, wherein the operations comprise:
chaining the subset of the list of functions in the order defined by the test sequence.

8. The system of claim 1, wherein the operations comprise:
obtaining definitions of operations of each function in the list of functions from an external source, wherein one or more changes to the operations performed by an individual function in the list of functions are automatically propagated to the page controller.

9. The system of claim 8, wherein the one or more changes comprise modifying an aspect of a portion of the GUI, and wherein the page controller is executed by the compiler to operate on the portion of the GUI with the modified aspect without being manually updated to reflect the one or more changes.

10. The system of claim 1, wherein the operations comprise:
calling the second function;
determining that the second function comprises a first condition;
analyzing an output of the GUI in response to calling the second function to determine whether the first condition is satisfied; and
waiting for the first condition to be satisfied before terminating execution of the second function.

11. The system of claim 10, wherein the operations comprise:
determining that the first condition has been satisfied;
in response to determining that the first condition has been satisfied, returning a result associated with the second function; and
calling the first function after verifying that the result associated with the second function has been returned.

12. The system of claim 1, wherein the page controller is a first page controller, and wherein the operations comprise:
accessing, by an individual function of the first page controller, one or more additional page controllers each having a respective set of functions.

13. The system of claim 1, wherein the operations comprise:
presenting a window depicting automated interaction with the GUI based on the subset of the list of functions being called.

14. A method comprising:
accessing, by a compiler using one or more hardware processors, a page controller associated with testing operations of a graphical user interface (GUI) of an application, the page controller comprising a list of functions representing respective interactions with the GUI, the page controller defining one or more conditions associated with executing functions in the list of functions;
calling, by the compiler, a subset of the list of functions of the page controller according to an order defined by a test sequence, a first function in the list of functions being dependent on a result of calling a second function in the list of functions; and
verifying operation of the GUI of the application in response to calling the subset of the list of functions.

15. The method of claim 14, further comprising:
accessing a code segment comprising the page controller and the subset of the list of functions.

16. The method of claim 15, wherein the code segment comprises a single line of code that causes the page controller to be executed based on parameters comprising the subset of the list of functions.

17. The method of claim 15, further comprising:
receiving, by the compiler, user input that defines the code segment; and
processing, by the compiler, the user input as text to validate the user input based on test logic associated with the one or more conditions.

18. The method of claim 17, further comprising:
determining that the user input places a third function of the list of functions in a specified position in the test sequence;
determining that the third function is associated with an individual result that is excluded from outputs of prior functions in the list of functions that are placed before the third function; and
generating, by the compiler, a message indicating an error in the test sequence.

19. The method of claim 17, further comprising:
as characters of the text are being received, accessing a selection of functions from the list of functions that match the characters of the text; and
presenting a dropdown list comprising the selection of functions, wherein the selection of functions is based on available results of prior functions in the code segment that have been placed in the order before the characters of the text were received.

20. A machine-storage medium for storing instructions that, when executed by one or more hardware processors, cause the one or more hardware processors to perform operations comprising:
accessing, by a compiler, a page controller associated with testing operations of a graphical user interface (GUI) of an application, the page controller comprising a list of functions representing respective interactions with the GUI, the page controller defining one or more conditions associated with executing functions in the list of functions;
calling, by the compiler, a subset of the list of functions of the page controller according to an order defined by a test sequence, a first function in the list of functions being dependent on a result of calling a second function in the list of functions; and
verifying operation of the GUI of the application in response to calling the subset of the list of functions.
